(19) United States
(12) Patent Application Publication
(10) Pub. No.: US 2008/0105010 A1
(43) Pub. Date: May 8, 2008

(54) DOOR LOCK ASSEMBLY HAVING A CAM ASSOCIATED WITH A HANDLE TO TRANSMIT MOVEMENTS TO A LATCH OPERATING SPINDLE

(76) Inventors: Wei-Liang CHIANG, Chiayi City (TW); Kun-Chen LEE, Chiayi County (TW)

Correspondence Address: LADAS & PARRY LLP, 224 SOUTH MICHIGAN AVENUE, SUITE 1600, CHICAGO, IL, 60604, US

(21) Appl. No.: 11/936,229

(22) Filed: Nov. 7, 2007

(30) Foreign Application Priority Data
Nov. 8, 2006 (TW) 095219765

(51) Int. Cl. G05G 5/00

(52) U.S. Cl. 70/224

(57) ABSTRACT

A door lock assembly includes a cam attached to a handle for rotating a rotary drive in response to rotation of the handle. The rotary drive has a driven part rotated by the cam, and a drive part opposite to the driven part. A latch operator is rotated by the drive part so that a latch operating spindle connected to the latch operator can retract a latch. A slide plate is controlled by a key-operated lock unit to prevent or permit rotation of the cam and the latch operating spindle. The door lock assembly is simple in construction and can be assembled easily.

### CROSS-REFERENCE TO RELATED APPLICATION

This application claims priority of Taiwanese Utility Model Application No. 095219765 filed on Nov. 8, 2006.

### BACKGROUND OF THE INVENTION

1. Field of the Invention

This invention relates to a door lock assembly, more particularly, to a door lock assembly for a fireproof door, which has a cam associated with a handle to transmit movements to a latch operating spindle.

2. Description of the Related Art

According to construction laws, it is required that a fireproof door be installed in a staircase on each floor of a building. In order to prevent fire from moving from one floor to an adjacent floor, the fireproof door is normally closed. However, for emergency exit or safety purposes, the fireproof door is provided with a door latch device which can be readily operated from the inside of the door. Generally, a door latch installed at the inside of the door includes a handle frame installed on the middle of the door. By pressing a handle disposed inside the handle frame, the door can be unlatched and opened. The fireproof door is further provided with a door lock assembly which includes a handle and a key-operated lock. The user may operate the handle and the key-operated lock from the outside of the door to lock or unlock the door. Examples of door lock assemblies for fireproof doors are disclosed in U.S. Pat. Nos. 5,445,423, 5,516,161, 5,658,026, 5,664,816, and 7,181,940.

### SUMMARY OF THE INVENTION

An object of the present invention is to provide a door lock assembly for a fireproof door, which has a simple construction and which can be assembled easily.

According to one aspect of this invention, a door lock assembly comprises: a housing; a handle connected to the housing; a cam attached to the handle inside the housing and rotatable along with the handle; a rotary drive disposed rotatably in the housing and having a driven part rotated by the cam, and a drive part opposite to the driven part; a latch operator disposed rotatably in the housing and driven by the drive part of the rotary drive; and a latch operating spindle adapted to operate a latch and connected to the latch operator for rotation along with the latch operator.

According to another aspect of the invention, a door lock assembly comprises: a housing having two aligned support rods; a handle connected to the housing; a latch operating spindle adapted to operate a latch; a cam attached to the handle inside the housing for transmitting rotation of the handle to the latch operating spindle; a key-operated lock unit provided in the housing; a slide plate disposed movably between the cam and the lock unit and movable between a locking position that limits the handle from rotation, and an unlocking position that permits the handle to rotate. The slide plate has two aligned guide holes respectively receiving the support rods in a slidable relationship. A coiled spring is sleeved around one of the support rods and resiliently positions the slide plate.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded view of the first preferred embodiment of the present invention;

FIG. 2 is a perspective view of the first preferred embodiment in which a cover plate is removed;

FIG. 3 is a plan view of a first preferred embodiment in an unlocking position;

FIG. 4 is the same view as FIG. 3, but showing that a cam is rotated;

FIG. 5 is the same view as FIG. 3, but showing a locking position of the first preferred embodiment;

FIG. 6 is an exploded view of the second preferred embodiment in which a slide;

FIG. 7 is a perspective view of the second preferred embodiment in which a cover plate is removed;

FIG. 8 is a plan view of the second preferred embodiment in the unlocking position; and

FIG. 9 is the same view as FIG. 8, but showing the locking position of the second preferred embodiment.

### DETAILED DESCRIPTION OF THE PREFERRED EMBODIMENTS

Before the present invention is described in greater detail, it should be noted that same reference numerals have been used to denote like elements throughout the specification.

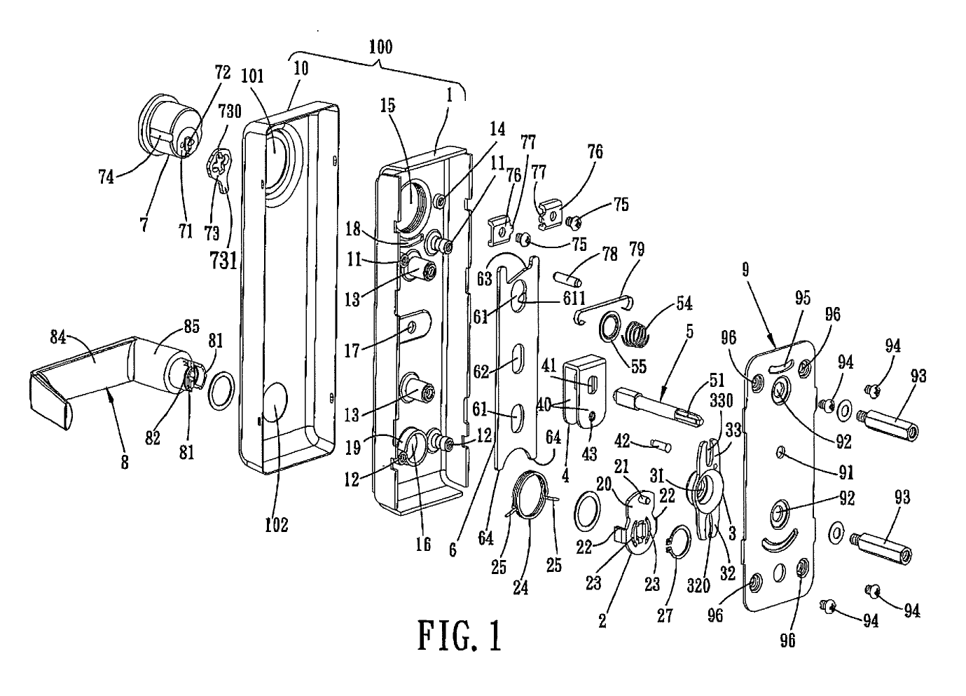

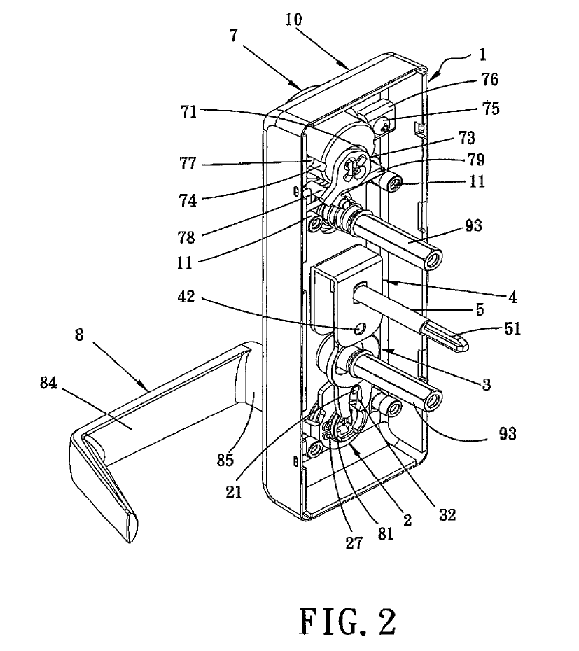

Referring to FIGS. 1 and 2, there is shown a door lock assembly according to a first embodiment of the present invention, which includes a housing 100 composed of an inner case 1 and an outer case 10. A cover plate 9 is connected to the inner case 1. The inner case 1 is provided with two guide rods 11, two screw rods 12, two support rods 13, a handle hole 16, a passage hole 17 and a tubular flange 19. The outer case 10 surrounds the inner case 1, and has a handle hole 102 aligned with the handle hole 16.

The door lock assembly further includes a handle 8, a cam 2, a rotary drive 3, a latch operator 4, a latch operating spindle 5, a slide 6, and a key-operated lock unit 7.

The handle 8 is connected to the housing 100, and has a grip portion 84 and a tubular body 85. The tubular body 85 has one end that is formed with two spaced apart lugs 81 and a groove 82 and that extends through the handle holes 102 and 16 of the outer and inner cases 10 and 1.

The cam 2 has two slots 23 for extension of the respective lugs 81 formed at one end of the tubular body 85. A locking ring 27 is engaged in the groove 82 so that the cam 2 is rotatable along with the handle 8 within the housing 1. The cam 2 has two opposite tongues 22 extending in an axial direction of the cam 2. A torsion spring 24 is disposed in the inner case 1 around the tubular flange 19 of the inner case 1, which in turn extends around the end of the tubular body 85. The torsion spring 24 has two legs 25 supported on the respective second screw rods 12. Each leg 25 is engageable with one of the tongues 22 to apply a returning force to the cam 2. Therefore, when the handle 8 is rotated by an angle, it can return to its original position. A protrusion 21 is formed on a lug portion 20 of the cam 2.

The rotary drive 3 is disposed in the housing 100 and has a central hole 31. The rotary drive 3 is sleeved rotatably around one of the support rods 13 fixed to the inner case 1 substantially in parallel with the latch operating spindle 5 and disposed between the latch operating spindle 5 and the handle 8. The rotary drive 3 further has a driven part 32, and a drive part 33 disposed on two sides of the support rod 13. The driven part 32 overlaps with the lug portion 20 of the cam 2, and has an engaging groove 320 engaging the protrusion 21 of the cam 2 so that the rotary drive 3 can be rotated by the cam 2. The drive part 33 also has an engaging groove 330.

The latch operator 4 is disposed rotatably in the housing 100, and is configured as a U-shaped plate having two holes 41, and a pair of spaced apart lobe portions 40. The latch operating spindle 5 is fixed in the holes 41 for rotation along with the latch operator 4. The latch operating spindle 5 passes through a spindle hole 62 in the slide plate 6, and extends rotatably into the passage hole 17 in the inner case 1 and a first slot 91 in the cover plate 9. A latch operating end 51 of the latch operating spindle 5 is connected to a latch mechanism (not shown).

The lobe portions 40 overlap with the drive part 33 of the rotary drive 3. A protrusion 42 is provided on the lobe portions 40 to engage the engaging groove 330 of the drive part 33 so that the latch operator 4 can be driven by the drive part 33. Preferably, the protrusion 42 is configured as a pin 42 that has two ends respectively inserted into two holes 43 (only one is shown) in the lobe portions 40 so that the protrusion or pin 42 is held by the lobe portions 40. The drive part 33 extends inbetween the lobe portions 40 to engage the protrusion or pin 42.

The cover plate 9 is further provided with two second slots 92, and screw holes 96. The cover plate 9 is secured to the inner case 1 by using screws 94 connected to the respective screw holes 96 and the screw holes in the respective guide rods 11 and screw rods 12, thereby covering the cam 2, the rotary drive 3, the latch operator 4, and the slide plate 6. The latch operating end 51 of the latch operating spindle 5 extends through the first slot 91. Two mounting screw rods 93 extend through the respective second slots 92 and are attached respectively to screw holes in the support rods 13.

The housing 100 further has two screw holes 14 (only one is shown), a lock hole 15 and a curve slide hole 18 all of which are formed in the inner case 1, and a lock hole 101 formed in the outer case 10. A curve slide hole 95 is formed in the cover plate 9 in alignment with the slide hole 18.

The lock unit 7 is disposed in the lock holes 101 and 15, and has a key plug 71, a key hole 72 formed in the key plug 71, two diametrically opposite engaging elements 74, and a transmitting member 73 rotatable along with the key plug 71. The transmitting member 73 has a radially projecting transmitting tab 731. An operating key (not shown) can be inserted into the key hole 72 and a hole 730 of the transmitting member 73 to rotate the key plug 71 and the transmitting member 73. The engaging elements 74 interlock with respective retaining elements 77 of retaining plates 76 which are secured to the inner case 1 on two sides of the lock hole 15 by means of screws 75 and the screw holes 14.

The slide plate 6 is disposed movably between the lock unit 7 and the cam 2. The slide plate 6 has two aligned guide holes 61 on two sides of the spindle hole 62. The support rods 13 extend through the respective guide holes 61 such that the slide plate 6 is slidable with respect to the support rods 13. The spindle hole 62 receives one end of the latch operating spindle 5. The slide plate 6 further has an engagement part 63 formed on an upper edge thereof, and two abutment parts 64 formed on a lower edge thereof and abutting against the cam 2.

The slide plate 6 is resiliently positioned by a coiled spring 54. The coiled spring 54 is sleeved around the support rod 13 above the latch operator 4. One end of the coiled spring 54 is in abutment with the cover plate 9. Another end of the coiled spring 54 has a positioning ring 55 connected thereto. The ring 55 tapers slightly toward the guide hole 61 formed above the spindle hole 62, and extends partially into the guide hole 61. The guide hole 61 substantially resembles a figure of eight, and has two inwardly extending projections 611 to engage the positioning ring 55. The guide rods 11 are disposed on two sides of the slide plate 6 to guide the sliding of the slide plate 6.

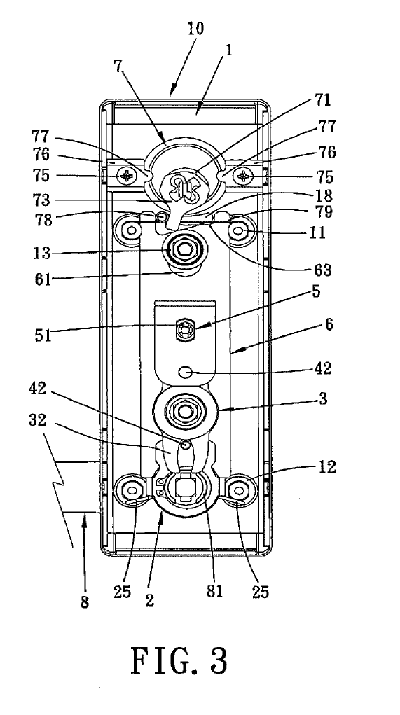

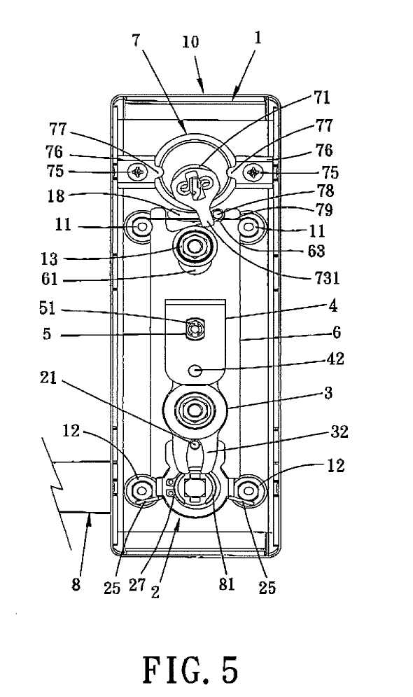

To place the slide plate 6 in a locking position or an unlocking position, the lock unit 7 controls and moves a pin 78 that extends transversely of the slide plate 6. The pin 78 has two ends extending movably through the curve slide holes 18 and 95 in the inner case 1 and the cover plate 9. The slide holes 18 and 95 are proximate to the upper edge of the elide plate 6. The pin 78 is pushed by the transmitting tab 731 to slide along the slide holes 18 and 95 so as to engage the engagement part 63 of the slide plate 6 (see FIG. 5), or to disengage from the engagement part 63 (see FIG. 3). When the pin 78 engages the engagement part 63, the slide plate 6 is in the locking position (see FIG. 5. When the pin 78 disengages from the engagement part 63, the slide plate 6 is in the unlocking position (see FIG. 3).

The pin 78 is biased by an elongate spring plate 79 which is disposed in the vicinity of the pin 78 and the slide holes 18, 95, and which has two ends respectively supported on the guide rods 11.

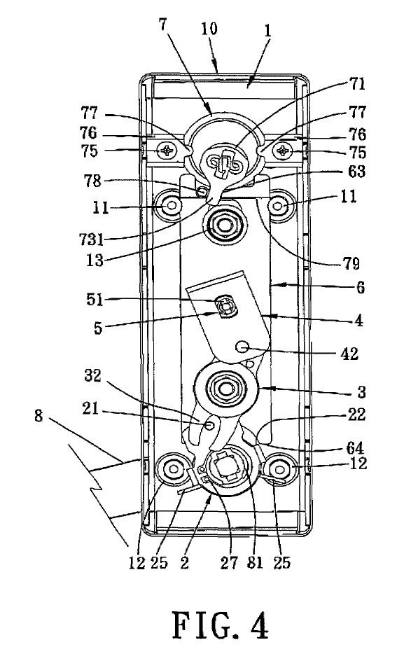

Referring to FIGS. 3-5 in combination with FIGS. 1 and 2, when the door lock assembly installed on a door is in its locking position, the key plug 71 and the transmitting member 73 may be rotated by a key (not shown) to push the pin 78 to disengage from the engagement part 63 so that the slide plate 6 permits the cam 2 and the handle 8 to rotate. At this time, the handle 8 can be rotated to move the cam 2 which in turn rotates the driven part 32 of the rotary drive 3. As a result, the drive part 33 rotates the latch operator 4 and the latch operating spindle 5 as shown in FIG. 4, thereby unlatching the door and permitting the door to open.

When the door lock assembly is in an unlocking position, the key plug 71 and the transmitting member 73 may be rotated by the key to push the pin 78 to engage the engagement part 63 (see FIG. 5). At this time, because the pin 78 engages the engagement part 63, the slide plate 6 is limited from moving upward so that the abutment part 64 which is in abutment with the cam 2 prevents the cam 2 and the handle 8 from rotation. As a result, the handle 8 cannot be rotated and the door cannot be unlatched.

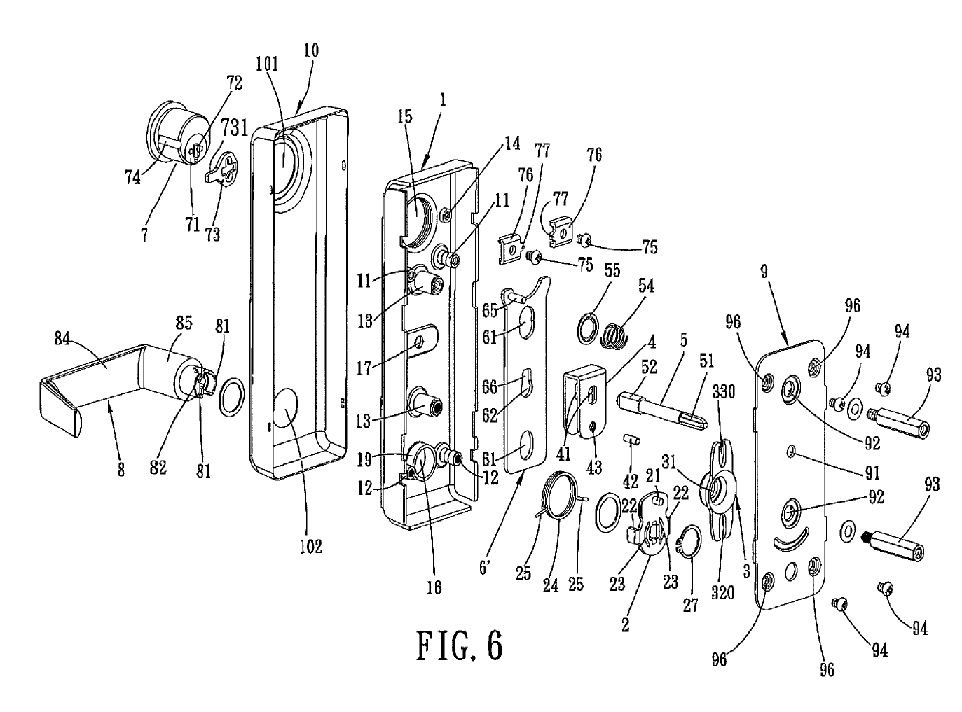

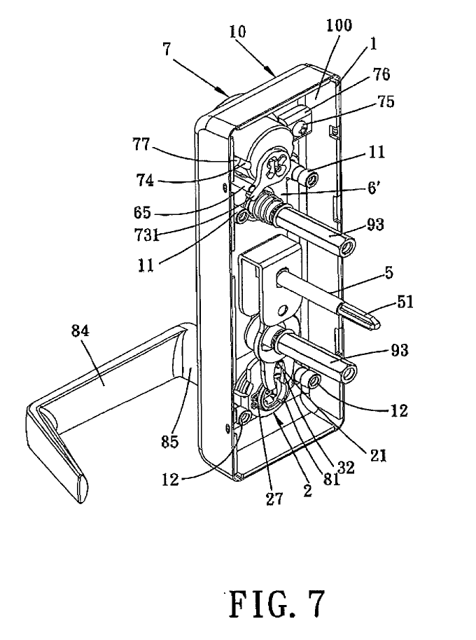

Referring to FIGS. 6-9, there is shown the second preferred embodiment of the present invention in which the slide plate 6′ is used in place of the slide plate 6 of the first preferred embodiment. The slide plate 6′ does not have the engagement part 63 and the abutment part 64. Furthermore, no slide holes 18 and 95 are provided in the inner case 1 and the cover plate 9. However, the pin 65 is formed on the slide plate 6′, and a locking part 66 is provided in the slide plate 6′.

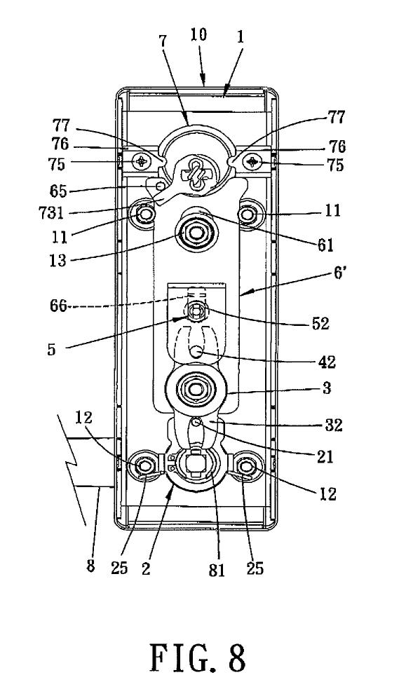

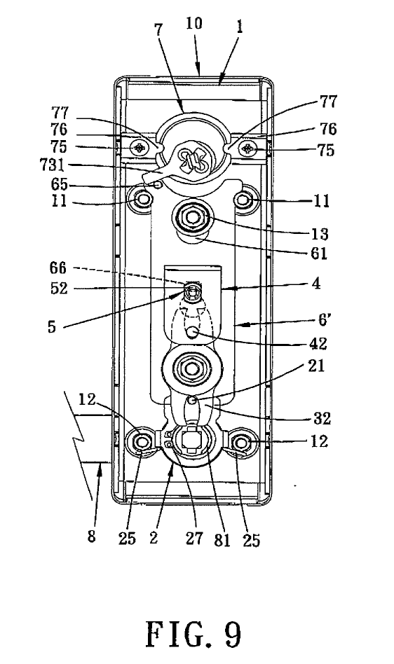

The locking part 66 is configured as a constricted hole section 66 formed in the spindle hole 62 of the slide plate 6′. The latch operating spindle 5 further has a detent portion 52 opposite to the latch operating end 51. The detent portion 52 extends into the spindle hole 62 and is engageable with the constricted hole section 66. When the lock unit 7 moves the pin 65, the slide plate 6′ is moved between its locking position in which the locking part 66 engages the detent portion 52 (see FIG. 9) and its unlocking position in which the locking part 66 disengages from the detent portion 52 (see FIG. 8).

When the door lock assembly is in its unlocking position and when the key plug 71 and the transmitting member 73 are rotated, the transmitting tab 731 moves upward the pin 65 and the slide plate 6′ so that the locking part 66 disengages from the detent portion 52 as shown in FIG. 8. The slide plate 6′ is therefore in its unlocking position that permits the latch operating spindle 5, the latch operator 4, the rotary drive 3, the cam 2 and the handle 8 to rotate.

When the door lock assembly is in its locking position and when the key plug 71 and the transmitting member 73 are rotated, the transmitting tab 731 moves downward the pin 65 and the slide plate 6′ so that the locking part 66 engages the detent portion 52 as shown in FIG. 9. The slide plate 6′ is therefore in its locking position that prevents the latch operating spindle 5, the latch operator 4, the rotary drive 3, the cam 2, and the handle 8 from rotating.

While the preferred embodiments described hereinbefore are provided with the components, such as, the key-operated lock unit 7, the pins 78, 65 and the slide plates 6, 6′, the present invention should not be limited thereto. The present invention may be embodied by dispensing with those components. In this case, the door lock assembly of the present intention is operated without using any key. The latch operating spindle 5 can control a latch (not shown) when operated by the handle 8 through the cam 2, the rotary drive 3, and the latch operator 4.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A door lock assembly comprising:
a housing;
a handle connected to said housing;
a cam attached to one end of said handle inside said housing and rotatable along with said handle;
a rotary drive disposed rotatably in said housing and having a driven part rotated by said cam, and a drive part opposite to said driven part;
a latch operator disposed rotatably in said housing and driven by said drive part of said rotary drive; and
a latch operating spindle adapted to operate a latch and connected to said latch operator for rotation along with said latch operator.

2. The door lock assembly of claim 1, further comprising a support rod fixed to said housing substantially in parallel with said latch operating spindle and disposed between said latch operating spindle and said handle, said rotary drive being supported by said support rod, said driven part and said drive part being disposed on two sides of said support rod, said cam having a lug portion engaging said driven part, said latch operator having a lobe portion engaging said drive part.

3. The door lock assembly of claim 2, wherein said lug portion and said driven part overlap each other, one of said lug portion and said driven part having an engaging groove, the other one of said lug portion and said driven part having a protrusion extending into said engaging groove.

4. The door lock assembly of claim 3, wherein said engaging groove is formed in said driven part, and said protrusion projects from said lug portion into said engaging groove.

5. The door lock assembly of claim 2, wherein said lobe portion and said drive part overlap each other, one of said lobe portion and said drive part having an engaging groove, the other one of said lobe portion and said drive part having a protrusion extending into said engaging groove in said lobe portion or said drive part.

6. The door lock assembly of claim 5, wherein said latch operator is configured as a U-shaped plate having a pair of said lobe portions that are spaced apart from each other, said protrusion being in the form of a pin having two ends held by said lobe portions, said drive part extending in between said lobe portions, said engaging groove being formed in said drive part and receiving said pin.

7. The door lock assembly of claim 1, wherein said cam has two opposite tongues extending in an axial direction of said cam, said housing has a torsion spring that is disposed around said one end of said handle and that has two legs supported on said housing, each of said legs being engageable with one of said tongues to apply a returning force to said cam and said handle.

8. The door lock assembly of claim 1, further comprising a lock unit disposed in said housing, a slide plate disposed movably in said housing between said lock unit and said cam, and a pin controlled and moved by said lock unit such that said slide plate is placed in a locking position or an unlocking position.

9. The door lock assembly of claim 8, wherein said lock unit has a key plug, and a transmitting member rotatable along with said key plug and having a radially projecting transmitting tab to control and move said pin, said pin extending transversely of said slide plate.

10. The door lock assembly of claim 9, wherein said slide plate has an abutment part in abutment with said cam, and an engagement part opposite to said abutment part, said pin being slidable within said housing to engage or disengage from said engagement part.

11. The door lock assembly of claim 10, wherein said housing has a slide hole proximate to an edge of said slide plate, said engagement part being formed on said edge of said slide plate, said pin being slidable along said slide hole.

12. The door lock assembly of claim 11, further comprising a cover plate fixed to said housing and covering said slide plate, said latch operator, said cam, and said rotary drive, said latch operating spindle extending through said cover plate.

13. The door lock assembly of claim 12, wherein said cover plate has a slide hole aligned with said slide hole of said housing, said pin having two ends extending into said slide holes of said housing and said cover plate, said housing further having an elongate spring plate having two ends supported by said housing so as to bias said pin.

14. The door lock assembly of claim 8, further comprising two retaining plates, said housing having a lock hole receiving said lock unit, said retaining plates fixed to said housing on two sides of said lock hole and respectively having retaining elements, said lock unit having two diametrically opposite engaging elements respectively interlocking with said retaining elements.

15. The door lock assembly of claim 9, wherein said pin is disposed on said slide plate, said slide plate having a locking part engageable with said latch operating spindle.

16. The door lock assembly of claim 15, wherein said slide plate further has a spindle hole which has a constricted hole section to form said locking part, said latch operating spindle having a detent portion extending into said spindle hole and engageable with said constricted hole section.

17. The door lock assembly of claim 16, further comprising a cover plate fixed to said housing and covering said slide plate, said cam, said rotary drive, and said latch operator, said latch operating spindle having a latch operating end that is opposite to said detent portion and that extends through said cover plate.

18. The door lock assembly of claim 8 further comprising a coiled spring, said slide plate having two aligned guide holes, said housing further having two support rods respectively extending into said guide holes in a slidable relationship, said coiled spring being sleeved around one of said support rods and resiliently positioning said slide plate.

19. A door lock assembly comprising:
a housing having two aligned support rods;
a handle connected to said housing;
a latch operating spindle adapted to operate a latch;
a cam attached to said handle inside said housing for transmitting rotation of said handle to said latch operating spindle;
a key-operated lock unit provided in said housing;
a slide plate disposed movably between said cam and said lock unit and movable between a locking position that limits said handle from rotation, and an unlocking position that permits said handle to rotate, said slide plate having two aligned guide holes 61 respectively receiving said support rods in a slidable relationship; and
a coiled spring sleeved around one of said support rods and resiliently positioning said slide plate.

20. The door lock assembly of claim 19, wherein said coiled spring has two opposite ends, one of which abuts against said cover plate, and the other one of which has a positioning ring that is sleeved around said one of said support rods and that is engaged in an adjacent one of said guide holes.
